(19) United States
(12) Patent Application Publication
(10) Pub. No.: US 2001/0047270 A1
(43) Pub. Date: Nov. 29, 2001

(54) Customer service system and method

(76) Inventors: David L. Gusick, New York, NY (US); Eric M. Goldberg, Bronx, NY (US)

Correspondence Address: PENNIE AND EDMONDS, 1155 AVENUE OF THE AMERICAS, NEW YORK, NY, 100362711

(21) Appl. No.: 09/783,929

(22) Filed: Feb. 15, 2001

Related U.S. Application Data
(60) Provisional application No. 60/182,851, filed on Feb. 16, 2000.

(51) Int. Cl. G06F 17/60

(52) U.S. Cl. 705/1; 707/104.1

(57) ABSTRACT

A customer service system and method are provided to enable different parties or organizations to communicate or share customer service information with one another. Different parties may be enrolled as members of a customer service network, and representatives from those parties can communicate with one another and share information knowledge. In particular, parties can forward or assign customer inquires to other parties (both in and out of the network) who may be more capable or competent to respond to a customer query. Parties in the network may also subscribe to customer service information published by other parties in the network.

### CROSS-REFERENCE TO RELATED APPLICATION

This application claims the benefit of priority from United States Provisional Application No. 60/182,851 filed Feb. 16, 2000 and entitled “System and Method for Providing Online Customer Service Information from a Plurality of Vendors”.

### FIELD OF INVENTION

The present invention relates to the fields of customer service support systems and information networks, and more particularly to a system and method for providing and sharing customer service information.

### BACKGROUND OF THE INVENTION

Customer service support systems are an important part of any organization that deals with members of the public, such as a “bricks and mortar” or e-commerce vendor that sells products or services, a manufacturer or supplier of goods, a university, a government agency, a library, or any other organization from which individuals may request information. Customer service is especially important for vendors, retailers, and manufacturers, since customer satisfaction is generally the foundation and mainstay of a business.

In conventional customer service systems, an organization employs individuals to personally answer and address all customer inquiries. However, due to the extensive resources and high costs associated with running such support systems, especially when employing individuals as customer service operators, it is desirable for an organization to automate, at least in part, its customer service system. For instance, many businesses provide customers with access to Internet World Wide Web (“Web”) sites, where a customer can find a list of frequently asked questions (FAQ) and their corresponding answers. The organization categorizes, organizes, and/or cross-references the questions and answers into a customer service knowledge base. In this manner, customers visiting the site can browse or search the knowledge base and have their questions answered without the requirement of human intervention (“e-service”). For example, U.S. Pat. No. 5,895,466 to Goldberg et al. discloses a customer service system including a natural language device that receives a textual question over a network from a customer using a remote device, analyzes the question, queries a databases, and provides an answer to the remote device over the network.

In many cases, a customer may pose a question for which an answer is not provided in the organization's knowledge base. As a result, dynamic systems have been proposed in which the customer service knowledge base is updated as new questions are answered. For example, the RightNow Web service from RightNow Technologies, Inc. of Bozeman, Mont. provides a dynamic, automated, FAQ generation, keyword searching, and personal assistance utility for customers to dialog directly with support personnel over the Web. In this system, if no FAQ is available to answer a question, the question is provided to a customer service representative of the organization. Once answered, the question and resulting answer can be added to an “organic” knowledge base to help subsequent customers (i.e., the knowledge base grows as new information is requested).

However, an organization's Q&A knowledge base and the knowledge of the organization's service personnel are often not adequate or competent to answer a question received from a customer. For example, a retailer may receive a specific question from one of its customers about a particular manufacturer's product, but not have any knowledge or information at its disposal to answer it. Such problems may occur frequently when organizations have a large inventory and/or frequent product-line turnover. As a result, customers may often not receive a quick answer to their questions (if they receive one at all), leading to customer dissatisfaction, aggravation, and often a loss of business.

A further disadvantage associated with present on-line or automated customer service (or e-service) systems is that customers are generally limited to accessing those systems in a conventional manner over the Internet, e.g., by browsing the organization's Web site or sending the organization an e-mail from their homes. This is generally unsuitable for customers who have inquiries while shopping for products or services at a retailer's or organization's location. For this reason, businesses still commonly employ a number of sales persons or customer service representatives to deal with customer inquires at in-store locations, and this generally requires an organization to devote considerable costs and resources for this purpose.

Thus, there is a need for a more efficient and effective customer service system able to quickly and inexpensively deal with customer service inquiries when an organization's existing knowledge base and the knowledge of the organization's service personnel are not adequate or competent to respond to the inquiry. Furthermore, a customer service system that is able to accommodate customer service inquires, in particular product-specific inquires, from customers shopping at a retailer or organization location would also be highly desirable.

### SUMMARY OF THE INVENTION

The present invention provides a customer service system and method that enables different parties or organizations to communicate or share customer service information with one another. In this manner, an organization can leverage or use the knowledge and expertise of other parties to meet the organization's own customer service requirements and to build the organization's own customer service knowledge base. As a result, customer inquiries can be more efficiently and accurately responded to.

In a preferred embodiment, the customer service system enrolls different parties as members of a customer service network. Each party may gather existing customer service knowledge in a knowledge base (or database), and that knowledge together with the knowledge of a party's customer service representative(s) provides an information resource within the system.

The customer service system of the present invention allows customer service representatives from different organizations in the network to communicate with one another and share domain knowledge and information. In particular, parties can forward or assign customer inquires to other parties who may be more capable or competent to respond to a customer query. An organization that is a member of the customer service network may also publish customer service information, and other parties in the network may subscribe to that information. An out-of-network resource can also be used as a fallback when, for example, a customer query is submitted to an organization and neither that organization's expertise and knowledge nor another in-network organization's expertise and knowledge suffices to provide a response to the query.

A party may supplement its knowledge base by adding customer service information to it from other information resources in the customer service network, as well as possibly from out-of-network resources. In this manner, the customer service system helps a party avoid answering a question that was previously responded to—not necessarily a question previously responded to by that party, but potentially a question previously responded to by another party in the customer service network. The present invention thereby provides parties with a greater ability to provide customer service information automatically, without human or manual intervention.

In one aspect, the present invention provides a customer service system comprising a database for storing, for each of a plurality of parties in a customer service network, a knowledge base of customer service information. The customer service information in each of the knowledge bases preferably comprises a plurality of question and answer pairs that are categorized by topic. A system manager, comprising software (generally running on a system server computer), enables the sharing of customer service information between the parties in the network. The system can comprise a member interface for allowing a representative of a party to access and interact with the customer service system and a customer interface for receiving a query from a customer of a first party in the network (which the system manager preferably directs to a representative of the first party).

In one embodiment, the system manager enables the representative of the first party to search for a response to the query in the customer service information contained in the knowledge base of the first party. It also permits the first party to subscribe to at least part of the knowledge base of a second party in the network and thereby further enables the representative of the first party to search for a response to the query in the customer service information contained in the knowledge base of the second party. The system manager may further enable the representative of the first party to add customer service information in the knowledge base of the second party to the knowledge base of the first party. As another option, the system manager enables the representative of the first party to assign the query to another representative of the first party.

In another embodiment, the system manager enables the representative of the first party to assign the query to a second party in the network (the query is preferably directed to a representative of the second party). To facilitate such assignments, the system manager may provide the representative of the first party with a contact list comprising contact information for other parties in the network. The representative of the second party may search for a response to the query in the customer service information contained in the knowledge base of the second party. The system manager enables the second party to provide a response to the query to the representative of the first party. When this occurs, the representative of the first party can add the customer service information in the response provided by the second party to the knowledge base of the first party. The second party can also provide a response to the query directly to the customer.

In another embodiment, the system manager enables the representative of the first party to assign the query to a third party not in the network. Again, the representative of the first party may be provided with a contact list comprising contact information for other parties who are not in the network but are generally suitable candidates for providing a response. The third party may be provided with a link to access the system and, once accessed, the third party can provide a response to the query to the representative of the first party and/or directly to the customer. If permitted by the third party, the system manager enables the representative of the first party to add the customer service information in a response provided by the third party to the knowledge base of the first party.

In another aspect, the present invention provides a customer service system comprising a first knowledge base of customer service information associated with a first party and a second knowledge base of customer service information associated with a second party different from the first party. A system manager, comprising software, receives a query from a customer of the first party and thereafter enables customer service information contained in both the first and second knowledge bases to be searched in connection with the query.

In a further aspect, the present invention provides a customer service system comprising a first knowledge base of customer service information associated with a first party and a second knowledge base of customer service information associated with a second party different from the first party. A system manager, comprising software, allows a customer of the first party to search for customer service information contained in both the first knowledge base and the second knowledge base. The customer service information in each of the first and second knowledge bases preferably comprises a plurality of question and answer pairs, and the system manager may allow the customer to browse through question and answer pairs in each of the first and second knowledge bases The system manager also preferably allows the customer to submit a query and then attempts to match the query with customer service information in both the first and second knowledge bases, e.g. using natural language analysis. In a preferred embodiment, the system manager presents the customer with a customer service page on behalf of the first party. The customer service page may be a World Wide Web page accessible over the Internet, and a link to the customer service Web page may be provided on a Web site for the first party. Alternatively, the customer service page may be accessible at a kiosk located in an establishment (e.g., a retail store) of the first party.

In still another aspect, the present invention provides a customer service system comprising a knowledge base of product specific customer service information associated with products. A system manager, comprising software, receives a code (e.g., that has been typed or scanned in) specific to a particular product and, in response, enables customer service information contained in the knowledge base to be searched. Again, the system manager preferably enables an information requester (e.g., a customer or representative of a party) to browse through the customer service information or to submit a query that the manager will attempt to match with customer service information in the knowledge base. The query may further be routed, either automatically or by a representative to a supplier (e.g., the manufacturer) of the particular product. If the supplier provides a response to the query, the system manager enables a representative of the party managing the knowledge base to add customer service information in the response to the knowledge base. The system may also comprise a code scanner device, located at an establishment of the party, to provide a product code to the system manager. Alternatively, where the system manager is accessible to a customer over the Internet, the system manager may receive a product code from a portable device, such as a wireless telephone or a personal digital assistant, of a customer (optionally, the device may have a portable scanner that is integrated with or is an accessory to the device).

In yet another aspect, the present invention provides a method for providing customer service information in which access to a first knowledge base of customer service information associated with a first party and access to a second knowledge base of customer service information associated with a second party (different from the first party) is provided. The method then includes allowing a person, such as a customer or representative of the first party, to search for customer service information contained in both the first knowledge base and the second knowledge base. Once again, the person may be allowed to browse through question and answer pairs in each of the first and second knowledge bases, or the person may be allowed to submit a query and then an attempt is made to match the query with customer service information in both the first and second knowledge bases.

### BRIEF DESCRIPTION OF THE DRAWINGS

The objects and advantages of the present invention will be better understood and more readily apparent when considered in conjunction with the following detailed description and accompanying drawings which illustrate, by way of example, preferred embodiments of the invention and in which:

FIG. 1 is a block diagram illustrating how the customer service system of the present invention provides information to customers who seek information from parties that are members of a customer service network, in accordance with a preferred embodiment;

FIG. 2 is a process flow diagram illustrating how a customer interfaces with the front end of the customer service system to obtain customer service information;

FIG. 3 illustrates an example of possible content for a customer service Web page;

FIG. 4 is a block diagram illustrating the options available to the various parties, both in and out of the customer service network, with respect to how to deal with an unanswered question;

FIG. 5 is a process flow diagram illustrating how, in a preferred embodiment, customer service system operates to allow a dispatcher to answer a question in accordance the different options available to the dispatcher; and

FIG. 6 is a block diagram overview of the customer service information system in another embodiment of the present invention.

### DETAILED DESCRIPTION OF PREFERRED EMBODIMENTS

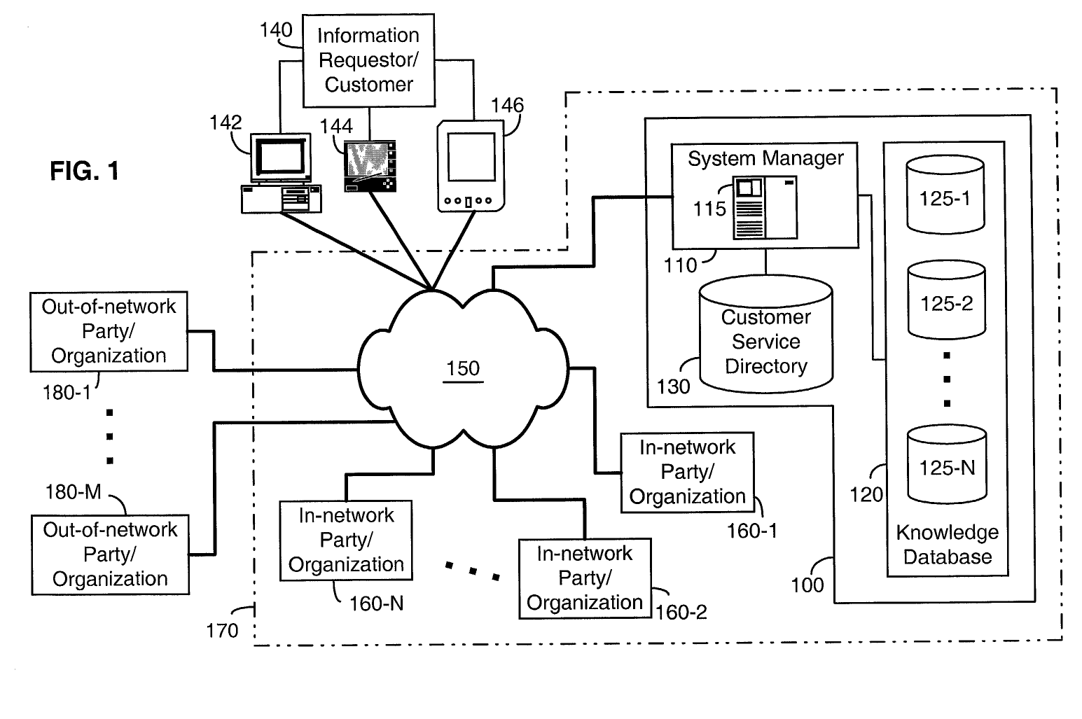

FIG. 1 is a block diagram overview of the customer service system 100 in accordance with a preferred embodiment of the present invention. In FIG. 1, system 100 provides information to customers (or information requestors) 140 who seek information from parties or organizations 160 that are members of a customer service network 170. Customer service system 100 comprises a system manager including system software for carrying out the operation of system 100, including the maintaining of a knowledge database 120 and a customer service directory 130. System manager 110 also provides an interface for information requesters 140, in-network parties 160, and out-of-network parties 180 to access system 100 and to communicate with system 100 and/or parties. System 100 is generally accessed by customers or parties over a communication network 150, which in a preferred embodiment comprises the Internet. In an alternative embodiment, customers or requesters 140 may, for example, communicate with customer service system 100 using a local area or private network and with parties 160 and 180 using the Internet. As illustrated in FIG. 1, system 100 may generally enable communication and the sharing of customer service information between any number of in-network parties 160-1, 160-2, . . . 160-N and any number of out-of-network parties 1801, . . . 180-M. Furthermore, any number of customers or information requestors may be served by system 100 at the same time, although only one customer block 140 is shown in FIG. 1 for the sake of clarity.

System Manager 110 comprises one or more server computer systems 115 (only one shown) running system software for allowing customers and parties to access and interface with system 100 and for enabling customers and parties to perform a variety of tasks in order to receive, provide, and share customer service information. Where system manager 110 comprises several server systems 115, these servers may be located in different geographic locations. System manager 110 also manages, administrates, and maintains customer service network 170. Typically, parties 160 who are members of network 170 are business organizations, such as retailers, vendors, e-commerce or online businesses, suppliers, distributors, manufacturers, service providers, and the like. Although parties 160 are generally referred to as organizations below, parties 160 may generally be any person, agency or organization that deals with members of the public and from whom individuals may request information, such as universities, government agencies, libraries, a doctor, a lawyer, etc. Furthermore, the term customer is intended to embrace any person, individual, or organization seeking information from a party 160, despite the fact that this term is most often used to refer to a customer or potential customer of a business organization 160.

Customer service system 100 signs up or enrolls parties 160 who wish to join customer service network 170 and receive the benefits of having system 100 manage their customer service inquiries as described in detail below. Upon registering with customer service system 100, a party 160 submits to system 100 certain information about the organization and assigns at least one person to respond to customer inquiries. Upon joining network 170, each organization 160 also fills or populates a portion of knowledge database 120 with customer service information, preferably general question and answer combinations that the organization believes or expects it will encounter in everyday operation (i.e., FAQs). In a preferred embodiment, as shown in FIG. 1, customer service knowledge database comprises distinct knowledge bases 125-1, 125-2, . . . 125-N, each of which is associated with an in-network party 160. As described below, the questions in each knowledge base are preferably organized into a hierarchy of topics and subtopics.

Generally, at least some in-network parties 160 have an existing business relationship or other nexus with one another that results in a potential overlap between the customer service inquiries that one party 160 may receive and another party 160's knowledge base. For example, a retailer may receive customer questions about products provided by a specific supplier, whereas the supplier might also receive questions about whether and for how much that product is sold at that particular retailer. Each of the supplier and the retailer in this case may not be equipped with sufficient knowledge to adequately or properly answer the inquiry. Similarly, a travel agency may receive questions about a specific travel destination that a tourism board for that travel destination is in a better and more informed position to answer. In this manner, each organization represents a knowledge or information resource, and for in-network parties 160 that knowledge is stored in an associated knowledge base 125 in system 100.

As a result, customer service system 100 preferably encourages a party 160 that joins network 170 to contact other organizations with which that party has an existing business relationship or other nexus, to suggest that those organizations also become part of customer service network 170. Thus, in the case of a retailer joining customer service network 170, that retailer may be encouraged to contact all of its suppliers (e.g., product manufacturers, product distributors, airline reservation systems, etc.). Although, it is generally in the interest of an in-network party 160 to have such other organizations join network 170—since this will help ensure that customer service inquires are dealt with most appropriately, as described in detail below—an in-network party 160 in customer service network 170 that is successful in soliciting other organizations to join the network may also be provided with an incentive reward, such as a discount or rebate in account charges. As indicated, as other parties 160 join customer service network 170, these parties establish a knowledge base 125 by filling customer service database 120 with more customer service information (in particular, question and answer combinations that these parties typically encounter when dealing with other organizations and/or customers).

As shown in FIG. 1, manager 110 maintains a customer service directory 130 created by system administrators that includes contact information for in-network parties 160 as well as for out-of-network parties 180 who decline to join customer service network 170. In a preferred embodiment, contact information for in-network parties 160 is maintained separately from contact information for out-of-network parties 180. For in-network parties, directory 130 preferably includes a list of account names as contact information. For out-of-network parties, directory 130 preferably comprises an e-mail directory of customer service contacts that contains the following information: a customer service e-mail address, customer service phone number, and a Web site URL. Out-of-network parties 180-1, . . . 180-M in directory 130 may be categorized as “out-of-network experts” (or out-of-network resources) that, as described below, may be contacted for answers to questions that cannot be answered by organizations in customer service network 170 (“in-network experts”).

In a preferred embodiment, customers 140 may access system 100 over the Web using a conventional or WAP (wireless application protocol) compliant Web browser and e-mail program. A customer 140 may therefore connect to network 150 using a computer 142 or a portable device 144 such as a handheld personal digital assistant (PDA) or a Web-enabled wireless telephone. Customers 140 may also access customer service system 100 using an in-store electronic kiosk 146 located in a business establishment of an in-network organization 160. Kiosk 160 may also connect to customer service system 100 over the Internet, but alternatively may connect to system 100, or a local sub-system thereof, for example over a local area network. In another embodiment, a customer may dial a designated telephone number and speak with a customer service representative, and the representative then interfaces with customer service system 100 through a computer terminal.

Preferably, organizations 160 participate in customer service network 170 by creating a link to customer service system 100. This may be accomplished by inserting a standard piece of html (or WML—wireless markup language) code into the organization 160's own Web site, e.g. as a “customer service” button in a navigation bar. Customer service system 100 may provide organizations 160 with tools and simple menu options to facilitate this process. The link to customer service system 100 preferably provides the user with a customer service Web page (or other type of interface) that is generated by system 100 and preferably served by a Web server associated with system 100 (e.g., as part of system manager 110)—and not by a Web server associated with organization 160's site. As a result, when joining network 170 an organization 160 generally does not need to make any investment in hardware or software, and can have an operational customer service Web page in very short time. However, in-network organizations 160 can select the type of information that will be presented to their customers (layout, text, logos, display of FAQs, menu options, and checklists for choosing different expert resources). In this manner, each organization in network 170 may maintain the look-and-feel of its own Web site, so that the customer server page simply appears to be an extension of the organization's site to customers 140.

Customers 140 interact with the customer service system 100 through the interface, e.g., the customer service Web page, set up by a particular organization 160 in system 100. Each party 160 preferably sets up an account in system 100, and that account may have different customer service pages having a different “look and feel” as well as the party's own preferences for what information in that party's knowledge base is accessible or displayed and how customer queries are handled. Also, as described below, an organization 160 may have more than one account with customer service system 100, and each of those accounts may have a separate and distinct link to the customer service system.

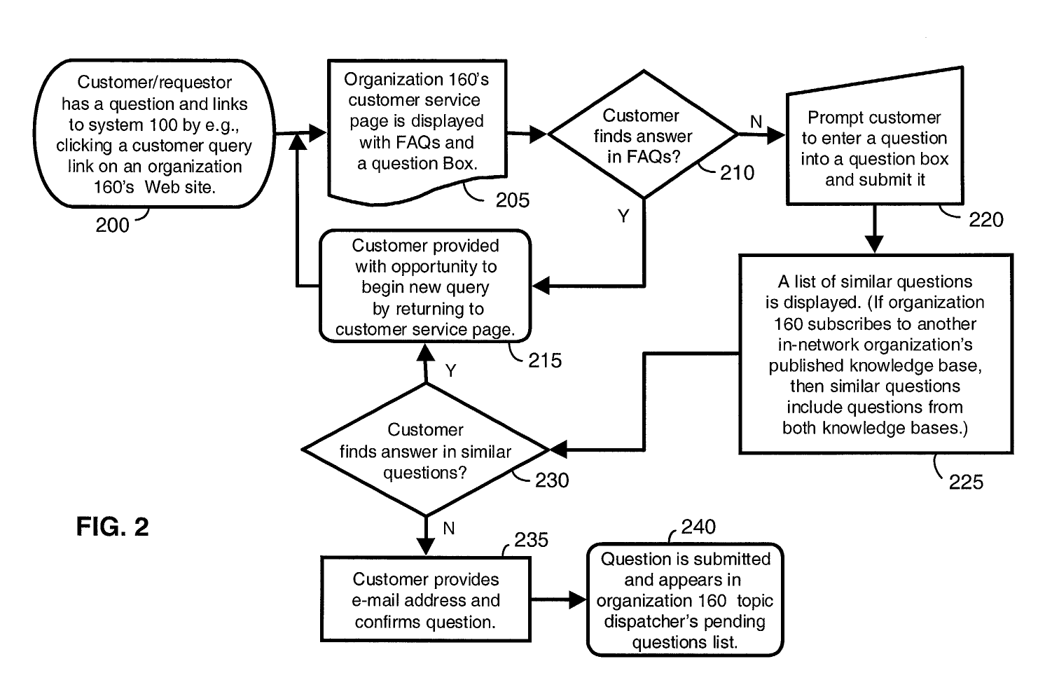

FIG. 2 is a process flow diagram illustrating how a customer 140 may interface with the front end of customer service system 100 to obtain customer service information. Referring to FIG. 2, at step 200 a customer or information requester having a question or inquiry for an in-network organization 160, visits that organization's Web site and clicks a customer query link on that site. Once a customer or information requester activates a link into the customer service network 170, the process of requesting information from the customer service network 170 begins. As indicated, each link is organization and/or account specific and therefore relates to information in that segment of the system knowledge database 120 that is relevant to the party or organization 160 that is hosting the link.

In another embodiment, a customer 140 may be provided with a list of information resources (knowledge bases) in customer service network 170 and the customer may be asked to specify which knowledge resource(s) to query. For example, a vendor organization 160's site may have a page with several information resource links for its various suppliers that are members in network 170. Similarly, a kiosk in a retail store environment of an organization 160 may provide, as a start display page, a list of information resource links corresponding to its various departments and suppliers. In these cases, the customer selects which information resource to direct its inquiry, and, upon doing so, is linked to a customer service Web page (or other similar interface).

At step 205, the customer service page that corresponds to the link (i.e., the particular organization's account) is displayed to the customer 140. The customer service page includes information resources that are relevant to the customer's starting point (usually, the organization 160's link to system 100). For example, the customer service contains relevant customer service information pertaining to the product or products in a particular category.

In one embodiment, general information, such as FAQs and possibly links to helpful web pages, is presented first followed by a question box or submission form. An organization may choose, for example, to display a static FAQ list or a dynamic FAQ list (e.g., displaying the most popular questions). Alternatively, in a preferred embodiment an organization provides a “drill-down” navigation scheme which allows the user to navigate to questions in a topic hierarchy that may span several Web pages.

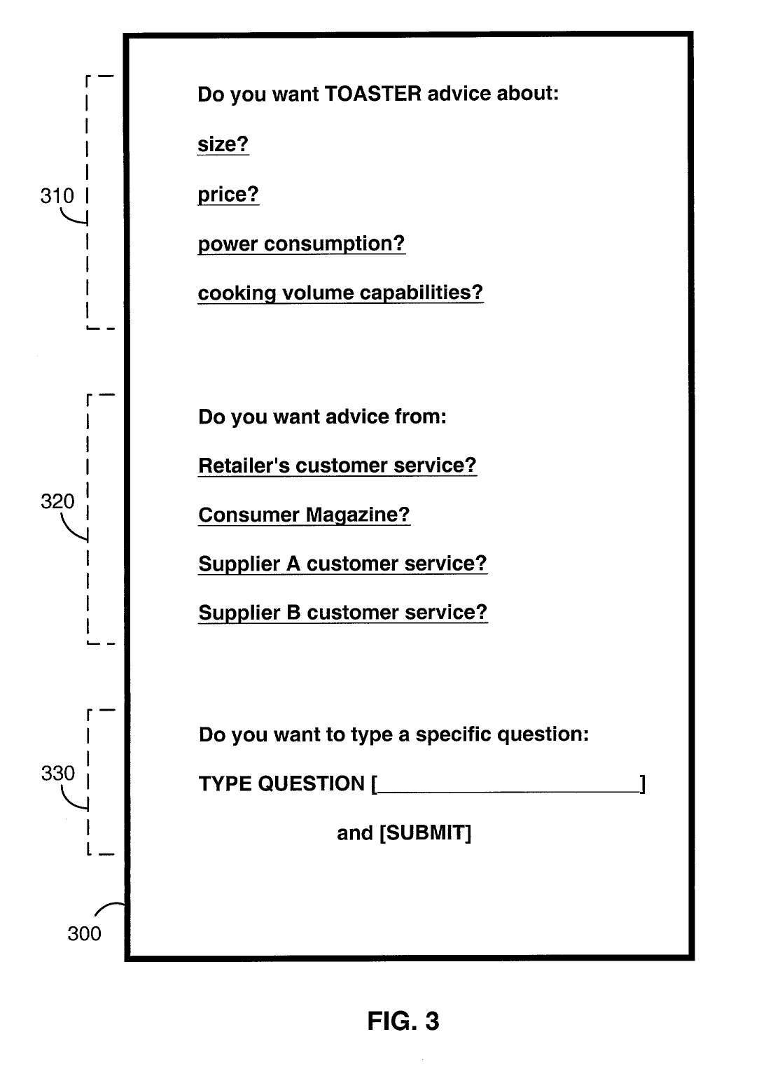

FIG. 3 illustrates the content 300 for an exemplary customer service Web page relating to toasters. In the example of FIG. 3, a customer who is considering purchasing a toaster, while browsing a retailer's (or e-tailer's) Web site, has a question and clicks on a customer service link that corresponds to an account and knowledge base relating to toasters in system 100 (e.g., “click here for advice about toasters”). As shown in FIG. 3, the content 300 of the customer service Web page displayed to a customer may comprise an FAQ area 310, a resource link area 320, and a query submission or question area 330. As shown, FAQ area 310 is organized using a drill down topic hierarchy and lists a number of subtopics in connection with the principal or top-level topic, toasters. In the example of FIG. 3, suitable subtopics include size, price, power consumption, and cooking volume capabilities. Similarly, resource area 320 may contain links to the retailer's main customer service Web page (which may be a separate system 100 account of the retailer), to consumer magazines/reports, product reviews (not shown in FIG. 3), and links to the customer service Web pages of suppliers who provide the retailer with toaster products. The suppliers may be in-network organizations 160 and/or out-of-network organizations 180. The information content of customer service Web pages in system 100, particularly FAQ information, is preferably maintained by system 100 as the knowledge base component 125 associated with the organization 160's account.

Furthermore, in addition to presenting customers with FAQs (or other information) in a party's own knowledge base, an in-network party 160 may subscribe to a knowledge base published by another in-network party. The subscribing party may then permit questions associated with all or some of the topics in the subscribed-to knowledge base to be presented to a customer. In this manner, a customer can search (e.g., by browsing, submitting natural language queries, key-word searching, etc.) customer service information in both a knowledge base associated with the party connected with the customer service page and second knowledge base associated with another party in network 170.

Referring again to FIG. 2, at step 210, the customer is prompted to browse through the FAQs to see if the answer to the customer's question is present in the customer service Web page(s) presented As indicated, FAQs are preferably organized into a hierarchy of topics, with one top level topic and several levels of subtopics, and with each question associated with one or more topics (or sub-topics). With the FAQs so arranged, a customer may browse through and find information in an organization's knowledge base with greater facility and convenience.

As shown at step 215, if while browsing the customer finds a suitable FAQ that provides the desired information, the customer may return to the top level customer service page and continue browsing in connection with another query (e.g., select another information resource link or another FAQ topic). Alternatively, a customer may decide to exit the process and return to the organization's Web site (or other location, such as a kiosk starting page, from which the customer originally linked to the customer service page).

Referring still to FIG. 2, if at step 210 a customer does not find the answer or information desired after browsing through the FAQs, the customer is provided with the option to submit a query, such as a typed question using an on-screen question box or form (area 330 in FIG. 3). This step is shown at step 220 in FIG. 2. In an alternative embodiment, a customer may submit a voice query, e.g., by speaking into a telephone or a microphone. System 100 may then use voice recognition techniques to convert the content of the query into a text format, or system 100 may digitally record the voice query and transmit it within the system as an audio file or attachment.

As above, if a customer does not wish to submit a query, the customer may return to the top level customer service page or to the organization 160's Web site. In accordance with a preferred embodiment of the invention, when submitting a typed question or other word-based query a customer types a free text statement describing what the customer wants to know, following prompts for where to type the statement and how to submit it. In addition, different submission options may be offered to the customer such as: (i) type and click submit button; or (ii) type, choose specific information resource to send question to, and click submit button.

In a preferred embodiment, the submitted word query is a question that is analyzed by a parser program included in the software run by system manager 110. That program “parses” the free text statement submitted by the requestor and queries the knowledge database for a question or information with same or similar meaning, preferably using natural language analysis. As will be appreciated, the natural language analysis may be based on one or more search /recognition techniques (such as Artificial Intelligence interpretation or weighted key word searches), and generally any suitable search technique may be used. In this manner, the question received from a customer 140 in step 220 can be matched against existing question and answer combinations in the knowledge database, to find one or more similar questions that have already been answered.

In a specific embodiment, the natural language query is compared against that segment of the knowledge database 120 that is relevant to the party or organization 160 who is hosting the initial web page (or kiosk) that the customer entered from, i.e., the particular knowledge base 125 corresponding to the organization 160 (or to the relevant account of organization 160) as well as published knowledge bases of other parties that have been subscribed to by that organization . As shown at step 225, after running a query, system 100 retrieves a question having the same meaning or a list of questions having a similar meaning and automatically displays the question(s) or question/answer combination(s) to the customer. As indicated, the list of similar questions may include questions from subscribed-to knowledge bases (or parts, e.g., only certain topics, thereof) as well. If, at step 230, the customer finds the sought-after answer or information in the list of questions returned in step 225, the customer may again return to the original site and/or make another customer service inquiry (step 215). It will be appreciated that up until this point in the customer service process flow, no manual intervention is required by anyone connected with customer service system 100.

If the customer does not find an appropriate question and answer combination, or or if the natural language analysis program does not find an acceptable match, the customer is provided with an option to submit the question to a customer service dispatcher (representative) associated with the particular in-network organization 160. If the customer selects this option, the customer is prompted to confirm the content of the question posed and to specify how the response should be delivered, preferably by providing an e-mail address, as shown at step 235. (Alternatively, a telephone number or a post-office address may be specified by the customer if system 100 supports those communication methods). After submitting the question to the customer service dispatcher, a message may be displayed indicating that the message has been forwarded to a customer service center or help desk. The message also preferably assures the customer that every effort is being made to answer the question in a timely fashion and that the customer will be apprized of the outcome of the effort, e.g., by e-mail, at regular intervals. (If no answer is eventually found, the customer is appropriately notified of that outcome as well.)

Optionally, in an alternate embodiment, when the natural language analysis program does not find an acceptable match, system 100 may automatically submit the question to a customer service dispatcher associated with the in-network organization 160 and display a message to the customer indicating that additional time is required to find an answer.

An in-network organization 160 preferably appoints one or more persons to act as a dispatcher to handle all such unanswered questions that are submitted by customers 140 in connection with a particular account or knowledge base. A question is considered “unanswered”, when the customer did not find an answer to the question by independently browsing through or searching for existing information in the knowledge base 125 associated with the account of organization 160. In effect, the dispatcher acts as an authorized representative of the organization 160 hosting the link from which the customer accessed customer service system 100. As questions are submitted, they are routed by system 100 to the designated dispatcher and placed in a queue in the dispatcher's pending questions list, as shown at step 240 of FIG. 2. Optionally, different dispatchers may be appointed in connection with different topics (or groups of topics) in an account's knowledge base. Preferably, security measures, such as the use of a login ID and password, are used to assure that only authorized personnel can access questions in the dispatcher's queue.

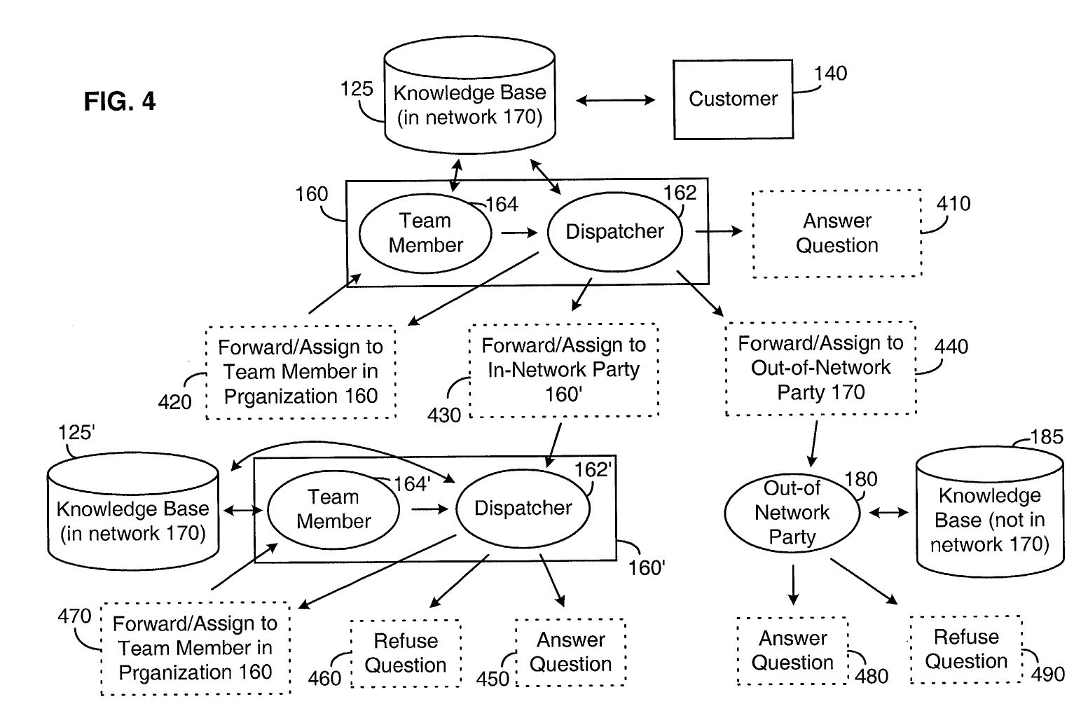

Once a dispatcher at an in-network organization 160 logs onto customer service system 100 (e.g., through an administration web site maintained by system manager 110) and accesses the dispatcher's pending questions list, system 100 provides the dispatcher with several options with regard to how to deal with a pending question. FIG. 4 is a block diagram illustrating the options available to the various parties, both in and out of customer service network 170, in dealing with a submitted question.

Referring to FIG. 4, a dispatcher 162 at organization 160 receives an unanswered question submitted by a customer 140. In accordance with a preferred embodiment, dispatcher 162 is provided with four options: (i) dispatcher 162 may answer the question using dispatcher 162's own knowledge, the knowledge base 125 associated with organization 160, and any other knowledge resources available to dispatcher 162 (option 410); (ii) dispatcher 162 may forward or assign the question to a person 164 in the same organization, typically a team member who is considered to have expertise with respect to the question (option 420); (iii) dispatcher 162 may forward the question to an in-network party or organization 160′ that is considered to have knowledge or expertise with respect to the question (option 430); or (iv) the dispatcher may select and then forward the question to an out-of-network party or organization 180 that is considered to have knowledge or expertise with respect to the question (option 440). In-network party 160′ typically has access to its own system 100 knowledge base 125′, while out-of-network party 180 may also have access to its own knowledge base 185. However, only the knowledge base 125′ of in-network party 160′ forms part of the overall knowledge base of customer service network 170.

As shown in FIG. 4, a question forwarded to an in-network party 160′ is also preferably received by a designated dispatcher 162′ (i.e., point of contact) in organization 160′. Thus, in a preferred embodiment, upon accessing system 100 a dispatcher of an in-network organization is provided with a pending questions list that includes both questions assigned by other in-network organizations and questions received directly from customers of the dispatcher's organization.

Thus, similar to dispatcher 162, dispatcher 162′ may answer the question using dispatcher 162's own knowledge and available resources (option 450), refuse the question and return it unanswered to dispatcher 162 (option 460), or further assign the question -e.g., to another team member 164′ in organization 160′ (option 470). Additionally, dispatcher 162′ could alternatively forward the question to another in-network party or to an out-of network party (options not shown).

Generally, a question forwarded by dispatcher 162 to an out-of-network party, which is typically an organization, may either be answered (option 480) or refused (option 490) by an individual associated with party 180. Questions sent to an out-of network organization 180 may also be initially directed to a general point of contact in the organization, e.g., a general information e-mail address.

As indicated above, where a customer query is voice based, and customer service system 100 digitally records the query, it may be sent to the designated dispatcher as an audio file or attachment. In this case, when a customer first enters a voice based query, system 100 may skip the step of trying to match the query to customer service information in a knowledge base and instead, immediately direct the voice recorded query to the dispatcher. The dispatcher may then listen to the query and answer it (e.g., with the dispatcher's own knowledge or by searching a knowledge base), preferably by submitting a typed e-mail response to the customer as described below. Alternatively, the dispatcher may forward the audio file or attachment to a team member, in-network party, or out-of-network party who in turn may listen to and answer the query.

To facilitate the assignment of questions to other parties, system 100 provides a dispatcher with a contact list of subject matter or topical experts to draw upon, both within and outside network 170. A customer service administrator in system 100 has the ability to add selected organizations to customer service directory 130, and each in-network party 160 can create a custom directory of experts for use in query or question forwarding, as described below. In addition, where a dispatcher refers a question to a team member, another in-network party, or an out-of-network party, customer service system 100 preferably implements tracking mechanisms, timeliness alerts, and/or communication tools that allow the dispatcher to follow-up on assigned customer service questions.

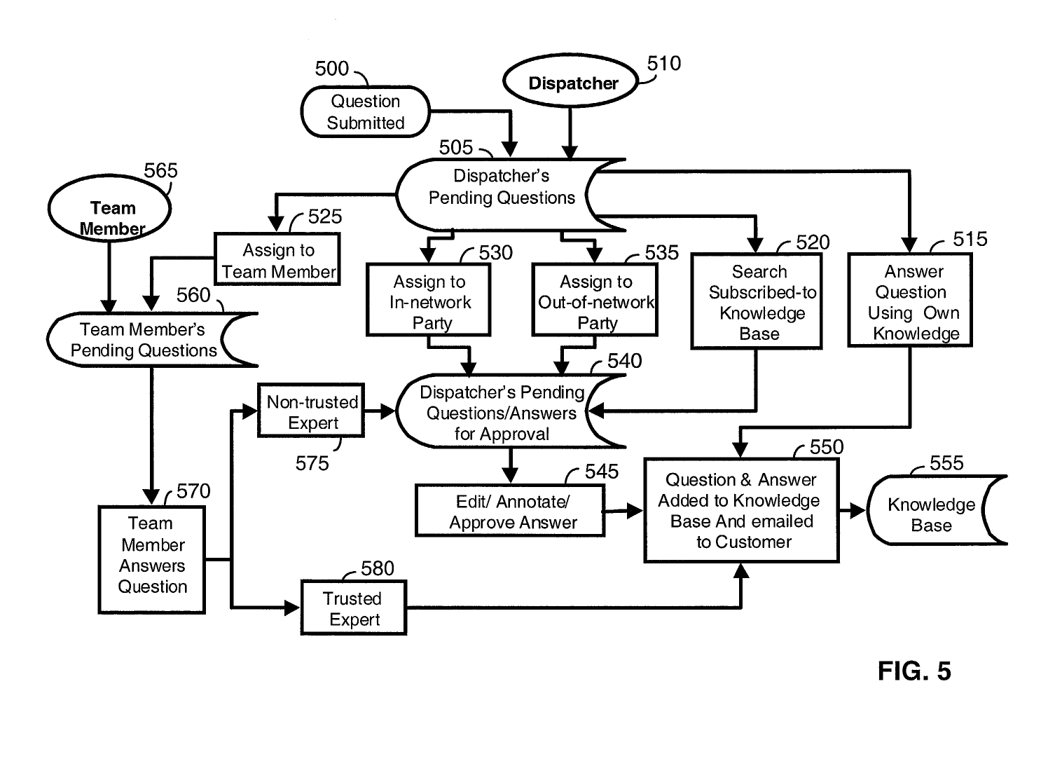

FIG. 5 is a process flow diagram illustrating how, in a preferred embodiment, customer service system 100 operates to allow a dispatcher of an in-network party 160 to have a question answered in accordance the different options described above. An unanswered question is submitted by a customer (or assigned by another in-network party) in step 500, and the question is thereafter routed by system 100 to the designated dispatcher's list or queue of pending questions in step 505. At step 510, the dispatcher logs into customer service system 100, typically from an Internet-connected computer terminal at the dispatcher's in-network organization. The dispatcher is then able to access the dispatcher's pending question list, to find the question submitted in step 500 (along with other questions routed to the same dispatcher from other team members or parties).

If the dispatcher is able to answer the question based on the dispatcher's own knowledge, the dispatcher preferably completes a standard response procedure in step 515. In one embodiment, the dispatcher completes three fields on a system 100 e-mail response screen: a typewritten answer to the question; a greeting to the customer requester (which may be either a typewritten note or a standard greeting from a menu of choices); and a salutation to the customer (again this may be either a typewritten note or a standard salutation from a menu of choices). The dispatcher then clicks a submit button to send the reply. The answer is routed to the customer, preferably to the return e-mail address specified by the customer when submitting the question, and stored in the knowledge database 120, as shown at steps 550 and 555. In this manner, database 120 (in particular the relevant knowledge base 125 associated with the topic of the question) is dynamically updated so that the question and answer combination can be re-used when another customer subsequently asks the same or a similar question.

Prior to attempting to have a question answered, the dispatcher may optionally run another query search against the knowledge base associated with the topic or account from which the question originated, preferably after reformulating the wording of the submitted question. In this manner, the dispatcher can further ensure that the sought after answer or information is not already present in that knowledge base. If the dispatcher does run another search and finds an answer to the submitted question, that answer may be submitted to the customer as described above.

In some cases a dispatcher may not know the answer to the submitted question but may know or suspect that the answer is found in a knowledge base that is published by another party 160 in customer service network 170 and subscribed to by the account or topic with which the dispatcher is associated. The publication and subscription of knowledge bases in customer service network 170 are described in more detail below. As indicated above, when a customer initially searches for an answer to a question, the list of similar questions and answers that are presented to the customer or queried by the natural language analysis program of system 100 may include questions and answers from a subscribed-to knowledge base as well as a knowledge base of the organization 160 that provided the customer with the link to system 100. Generally, a party 160 subscribing to another party's knowledge base may designate the subscribed-to knowledge base as public (i.e., searchable by customers of the subscribing organization) or private (i.e., searchable by a topic administrator or a dispatcher of the subscribing organization but not by a customer of the subscribing organization). Alternatively, a subscribed-to knowledge base may be designated partly public and partly private, for example with certain topics public and others private.

As a result, at step 520 in FIG. 5, the dispatcher may also search a subscribed-to knowledge base for the answer to the submitted question. The dispatcher may query a published knowledge base in a manner similar to that in which a customer initially queries a customer service Web page, i.e., by browsing through a categorized list of FAQs and/or entering a natural language or key word search query in a question box. Any answer(s) returned by the dispatcher's search in the published (and subscribed-to) knowledge base may be automatically transferred by system 100 to, and listed in, the dispatcher's list of pending questions/answers for approval, as illustrated at step 540. If the dispatcher finds the relevant information to answer the customer's question, the dispatcher may select the question/answer, insert it into a new answer format, edit the answer, and/or add any appropriate annotations at step 545, before submitting the answer to the customer at step 550. Again, the question and answer (if applicable, as edited by the dispatcher) are added to the knowledge base at steps 550 and 555, so that a similar question from a subsequent customer can be answered automatically by system 100.

If the dispatcher chooses to assign the question to a team member or expert in the same organization 160, the dispatcher preferably uses an account-specific system 100 menu to select the team member and send the question to the desired team member in step 525. Typically, the team member is a subject matter expert that the dispatcher believes will be better able to answer the question. The assigned question is routed into the team member's pending questions list, as shown at step 560 in FIG. 5. When the team member logs into customer service system 100, the team member finds the assigned question in the team member's pending questions list.

Preferably, a team member can pursue any of the options available to a dispatcher to have a question answered. Thus, a team member may forward the question to yet another team member or search a subscribed-to knowledge base (these possible steps are not shown in FIG. 5 for the sake of clarity). In one embodiment, it may additionally be possible for a team member to assign a question to an in-network party 160 or an out-of-network party 180. The team member can also refuse an assigned question, returning it to the dispatcher (who may then pursue another answering option).

A team member may thereby answer an assigned question at step 570 using the team member's own knowledge, an available information resource, or some other answering option. If the team member is a non-trusted expert (step 575) without the operational permission to modify the knowledge base or respond directly to a customer, the answer is routed back to the original dispatcher's list of pending questions/answers for approval at step 540. The dispatcher edits, annotates, and/or approves the content of the team member's answer at step 545. The answer is then sent to the customer and the question and answer are added to the knowledge base at steps 550 and 555. However, if the team expert is a trusted expert (step 580) with the operational privilege to modify the knowledge base or respond directly to a customer, the trusted expert may do so directly at steps 550 and 555, as shown in FIG. 5.

In a preferred embodiment, mechanisms are triggered within system 100 to allow a dispatcher to keep track of an assigned question's progress and status. For example, a clock may start upon the assignment process and be used to notify the dispatcher at regular intervals regarding the question's progress. In addition, a tally of how many questions have been sent to each individual team member may maintained so that the dispatcher can balance the distribution load and not assign too many questions to a single team member expert.

Referring still to FIG. 5, if at step 530 the dispatcher chooses to forward the question to an in-network party, i.e., the dispatcher again preferably uses a system 100 menu to select the in-network party considered to have expertise in the desired area and forwards the question on. For example, the dispatcher may be part of a vendor organization and may receive a question relating to a product of a specific supplier who is also an in-network organization. In this case, the dispatcher may determine that the supplier is in a much better position to answer the question posed by the customer. As described above, preferably questions are assigned to the in-network organization generally (i.e., to a dispatcher in that organization who then decides how best to deal with a question). However, in some embodiments questions may also be assigned directly to a particular individual or personality at an in-network organization.

In one embodiment, where a dispatcher initially selects an option to forward a question to an in-network party and the dispatcher's account subscribes to that in-network party's knowledge base, system 100 preferably first displays similar questions that already exist in the knowledge base of that in-network party. In this case, the dispatcher can select an appropriate answer, if found, that will then be routed back to the customer who asked the question, without having to involve an expert or other individual at the in-network party. If the dispatcher does not find an appropriate answer, the dispatcher confirms that the question should be forwarded.

Again, mechanisms are preferably triggered within system 100 to keep track of a forwarded question's progress. For example, a clock may be started upon the forwarding process and used to notify the dispatcher at regular intervals about the question's progress. Also, a tally of how many questions have been sent by the dispatcher's system 100 account to a given in-network party is maintained, so the dispatcher can balance the load and avoid assigning too many questions to a single organization.

As indicated, a question assigned to an in-network party 160 in step 530 is preferably routed to a dispatcher in that organization who accesses the question in a pending questions list after logging into customer service system 100. Thereafter, that dispatcher may pursue any of the options described above to provide an answer to the assigned question. If an individual or expert at the in-network party answers the question, the question is added to the knowledge base of an account associated with the in-network party (if not already present), and the answer is sent back at step 540 to the original dispatcher who forwarded the message as a pending question/answer for approval. At step 545, the original dispatcher may provide an annotation to the answer received from the in-network party expert before sending the question and answer to the customer who submitted the at step 550. (If the answer-providing in-network organization permits, the original dispatcher may also edit the answer prior to forwarding it to the customer.) The question and answer are also then added at step 550 to the knowledge base 555 (in addition to being previously added to the knowledge base of an account associated with the answer-providing in-network organization).

In an alternative embodiment, an individual or expert at the in-network party being assigned a question may answer the customer's question by sending an e-mail message directly to the customer. In this embodiment, the expert again preferably completes three fields on a system 100 response screen including a typewritten answer, a greeting to the customer, and a salutation to the customer. When the in-network expert submits the answer, it is delivered to the customer at the address specified by the customer and added to an appropriate knowledge database of the in-network expert's organization. Once the question is fully answered and the response goes to the customer, the original dispatcher is preferably notified by a system 100 online notification process. If the answer-providing in-network party permits, the question and answer may also be added to the knowledge base associated with the original dispatcher's organization.

Referring still to FIG. 5, as a further option, the dispatcher may also choose to forward the question to an out-of-network party 180 at step 535. An out-of-network party, which is typically an organization but may also be an individual, is generally considered to have subject matter expertise but is not a member of the customer service network 170. Preferably, however, an out-of network party 180 is considered to be a viable candidate for inclusion in the network. An out-of-network party's contact information is maintained in directory 130, and a link is provided in the dispatcher's contact list. Thus, for example, when a dispatcher is unsuccessful in attempting to have a question answered by the dispatcher's own organization or through an in-network resource, the dispatcher may contact an out-of-network party expert to solicit help.

A dispatcher may user a customer service system 100 menu list to select an out-of-network expert. In a preferred embodiment, the menu list is prepared through a separate methodology of identifying potential out-of-network experts with basic demographics, professional credentials, and e-mail addresses. The e-mail message or (other type of correspondence) formulated to the out-of-network expert may optionally include some background information regarding the current effort to have the question answered.

Preferably, the question is submitted to the out-of-network party 180 using a standard system 100 e-mail having embedded links and sent to an individual or general organization e-mail address (the unanswered question is preferably automatically attached to the e-mail message). The e-mail message may additionally include a solicitation for an out-of network organization 180 to join the customer service network. The use of embedded links facilitates the provision of a response by an out-of-network expert, as well as the processing of that response by customer service system 100. In this manner, prompts in the e-mail message can provide an easy to follow response format. For instance, there may be a “yes” or “no” option in an e-mail message to an out-of-network party expert, so that if the expert decides not to answer the question, the expert can simply click on a negative response link. The “no” link will change the status of the question in the dispatcher's list from “forwarded” to “returned unanswered.” The customer service dispatcher can then take additional steps to attempt to respond to the question. In addition, a dispatcher preferably may place a time limit on how long an out-of-network party has to respond to a question, so that if a question is not answered within the specified time limit, the question is also returned to the dispatcher as “returned unanswered.”

If the out-of-network expert chooses to answer the question, the expert can click on a positive response or “yes” link that automatically links the out-of-network expert into the customer service system 100. A one time access identification number is preferably embedded into the “yes” link so that the expert can gain access to the system without having to supply a user name & password to enter the system. The out-of-network expert preferably is taken to a page that displays questions that the expert and/or the expert's organization have previously responded to, along with additional marketing material encouraging them to join the network (with links to a member registration screen). Once the out-of-network expert has responded to the question, both the question and the response are returned to the dispatcher's queue. The question is labeled “returned answered.” Tracking mechanisms are again preferably used to keep the dispatcher abreast of the answer process. An “alarm process” may be used to ensure that the dispatcher is aware if the out-of-network party does not respond, and the dispatcher needs to pursue another option to obtain an answer.

In a one embodiment, if an out-of-network party answers the question, the answer is not “public” within customer service network 170. Instead, the answer is sent to the original customer, and the dispatcher is notified that the question was answered by the out-of-network expert. In an alternative embodiment (illustrated in FIG. 5), the out-of-network expert's response is sent to the dispatcher, in the list of questions/answers pending approval 540, and the dispatcher may then modify/approve the answer and forward it to the customer who asked the question.

As noted, if the out-of-network party 180 does not answer, the dispatcher must pursue other options, and repeated non-responsiveness may become problematic. Therefore, preferably a record is kept by system 100 of the out-of-network party 180's responsiveness. For example, system 100 may implement a rule in which after three instances of non-responsiveness, an out-of-network party is designated a poor candidate for the provision of future expertise and/or is removed from the contact list provided to dispatchers.

As indicated, enticements may be built into the out-of-network interface to influence an out-of-network expert (and, more specifically, the organization 180 with which the out-of-network expert is associated) to join customer service network 170. In particular, the out-of-network expert can be reminded of the importance of having customers exposed to the “voice” of organization 180 as opposed to, for example, misinformed sales persons. Furthermore, tracking mechanisms may tally the number of times the out-of-network expert was sent e-mails by the customer service network 170 and maintain statistics on how many times the expert did or did not answer. In this manner, the out-of-network party can be provided with statistical evidence demonstrating that joining customer service network 170 would save time since answers already provided would become “public” if the expert's out-of-network organization 180 became a member of network 170.

As illustrated in FIG. 1, a customer 140 may use any type of Web-enabled or network-connected device to connect to customer service system 100, including a portable device such as a personal digital assistant or a wireless telephone. In addition, as also shown in FIG. 1, an electronic kiosk 146 for interfacing with system 100 may be located in the business establishment, such as a retail store, of an in-network organization 160 where it can be accessed by customers. When using a portable device or in-store kiosk, a customer may advantageously be able to obtain customer service information while shopping or browsing in a retail store location.

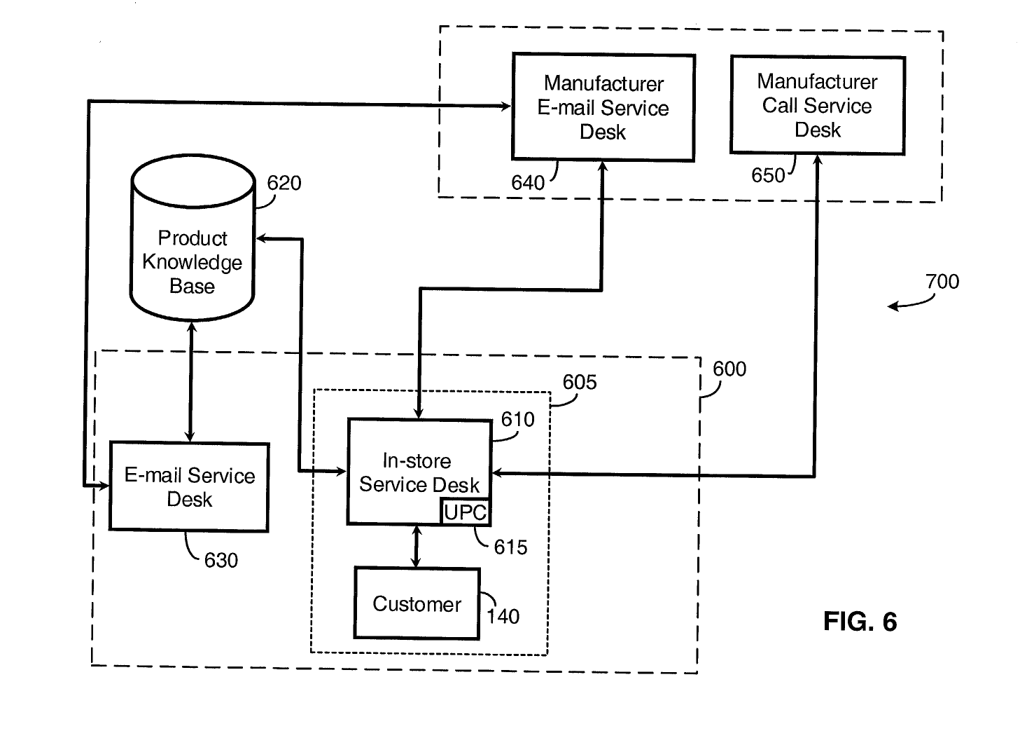

In accordance with another embodiment of the present invention, illustrated by a block diagram overview in FIG. 6, a customer service system 700 includes an electronic kiosk, customer service desk, or other similar in-store facility of an organization that is equipped with a product code scanner (or other product code input device). The product code scanner, which is preferably a UPC (Universal Product Code) bar code scanner/reader, enables the customer service system to rapidly and accurately identify customer service information relating to a particular product. In known manner, a UPC code includes a manufacturer identification number and an item number to uniquely identify a specific product from a specific manufacturer. The customer service system may also use other types of product/item codes (and scanners, if appropriate) such as an ISBN (International Standard Book Number) code used to identify books or an EAN (European Article Number) code.

In the illustrated embodiment of FIG. 6, customers 140 shopping in a store location 605 of a retail or vendor organization 600 may be advised (by way of signs, public address announcements, etc.) that if they have a question about a specific product sold by the store they should bring that product to a customer service desk 610. At service desk 610, a service representative is connected to customer service system 700 using, for example, a computer terminal (not shown). In this embodiment, FAQs (or other customer service information) stored in a knowledge base 620 associated with the organization 600 are preferably categorized or indexed by product. In this manner, when a service representative scans a UPC label attached to a product using a UPC bar code scanner 615 or the like, a system manager program or the like in system 700 receives the product-specific code and automatically identifies the product of interest. The manager in system 700 then allows the FAQs or customer service information in knowledge base 620 that relate to the particular product to be presented and searched, e.g., browsed through and/or queried by the customer or the service representative.

If, after browsing, the customer's question (i.e., sought after information) is not adequately answered by a FAQ then, the service representative preferably may enter a word-based query into a customer service system interface and submit it to find a match in the knowledge base, in a manner similar to that described above. System 700 then returns similar questions relating to the specific product (as above, where other knowledge bases are subscribed to these may also be queried at the same time). If the customer or service representative is still not satisfied with the information provided by the list of similar questions, the query may be submitted, preferably along with the customer's e-mail address, to an e-mail service desk 640 of the supplier of the product, typically the manufacturer as shown in FIG. 6 (but possibly also a distributor or other type of supplier), who is considered to be more capable of answering the question. Although preferred, it is not necessary that the manufacturer be a member, along with organization 160, of a customer service network. However, retail organization 600 may notify suppliers of products sold by organization 600 that it may submit questions from customers to the supplier, and organization 600 may request that the supplier confirm that it will accommodate and answer such questions. As will be appreciated, it will be generally be in the interest of a supplier to answer such questions since cooperation in that regard helps promote the supplier's own business.

Where a representative of the manufacturer answers the submitted question, the email response is provided to an e-mail service desk 630 of organization 600 as well as, in a preferred embodiment, to the customer who originally posed the question. Alternatively, the e-mail response may be forwarded to the customer by organization 600. In either case, a representative of organization 600 preferably edits or cleans up the response and ensures that the question and answer are properly entered into knowledge database 620. In this manner, retail organization 600 may rapidly build up a comprehensive FAQ knowledge base of customer service information that is easily accessible to customers interested in a specific product.

Optionally, if available, the service representative may also simultaneously attempt to contact a call center 650 of the manufacturer by telephone. In this manner, a customer may receive a more immediate response to the customer's question. However, even if an answer is provided by call center 650, the manufacturer's e-mail service 640 preferably still responds to the e-mailed question by sending a reply to service desk 630 of organization 600, where the answer is edited, if necessary, and added to knowledge database 620. The edited and annotated message may then also be sent to the customer who posed the original question.

In an alternative embodiment, a self-serve kiosk in store location 605 may include a UPC scanner/reader that the customer can operate. A customer can thereby scan a product and interface directly with the customer service system, without the need to involve a customer service representative. As a further alternative, instead of scanning in a UPC or other coded label, a customer or a service representative can enter (using a keypad or keyboard) the numeric or alphanumeric digits corresponding to the code in a designated field provided by a system 700 interface.

Thus, in yet a further embodiment, customers 140 may use network-enabled portable devices (such as wireless telephones or personal digital assistants) to access system 700 and thereafter enter a numeric or alphanumeric product-specific code. (Alternatively, the customer's portable device may be integrated or equipped with a scanner/reader to facilitate interfacing with system 700 directly). A customer may access customer service system 700 by, for example, visiting organization 600's WAP/WML enabled site (i.e., a web site that can be accessed using a wireless application protocol and wireless markup language compliant device) and selecting an “enter UPC code for customer service” or a “scan product UPC label for customer service” option. Advantageously in this embodiment, organization 600 need not provide nor maintain a service desk or kiosk, and a customer does not have to travel to a particular desk or kiosk within store location 605 nor wait in line to access customer service information.

In a variation of the embodiment shown in FIG. 6, a party managing customer service system (and not retailer 600) may also manage the content associated with knowledge base 620. Again, knowledge base 620 preferably includes question/answer pairs categorized by product, and this information may be further subcategorized by product line and/or supplier (e.g., manufacturer). In this embodiment, a customer or a representative of a subscribing party (such as retailer 600) may access knowledge base 620 by submitting a product specific code (such as a UPC or ISBN code) through any of the above-described system interfaces. As described above, when an information requester does not find sought-after information, a query may be submitted to the system. In this embodiment, the customer service system preferably routs the query automatically to an appropriate party that has been associated with the particular product code (typically the supplier of the product).

Preferably, if the query-receiving party is an in-network party as described above, the query may be forwarded to a designated representative (i.e., a dispatcher) who may pursue any of the options described above to have the query or question answered. On the other hand, if the query-receiving party is an out-of-network party, the system preferably sends the query by e-mail to an appropriate customer service e-mail address. An out-of-network party may then answer by selecting an affirmative response link that provides access to a specific response page in the customer service system or by simply sending a response by e-mail. In this embodiment, a response to a submitted query is routed to a representative of the party managing the customer service system. The representative of the system-managing party can then reword, edit, categorize, and approve the response before adding that information to knowledge base 620. The system-managing party's representative preferably then provides that information to the customer or representative who originally requested the information.

Advantageously, in this embodiment, knowledge base 620 may include customer service information pertaining to a wide range of products, and not just products sold by a particular retailer 600. By building up and adding to the contents of knowledge base 620 over time, the knowledge base may become a depository of information for all (or most) coded products. As a result, many different types of parties or retailers may want to subscribe or otherwise have access to the system-managing party's account that is associated with knowledge base 620.

System Model

The following description of the “objects” or concepts in customer service system 100 and customer service network 170, in a preferred embodiment of the invention, provides additional illustration of the features and operation of the present invention and may also be used to provide an object oriented model of system 100 (and where appropriate, customer service system 700 as well).

Accounts, Persons, and Topics

Accounts

Accounts are “top level” entities represented in customer service system 100. An Account preferably has a name and an ID number. An Account can be associated with zero or more Topics, and an Account can be associated with zero or more Customer Service Pages. An Account also preferably has a designated Primary Contact. System 100 preferably charges in-network parties 160 accounts so that all Topics and Customer Service Pages under an Account are billed together.

Persons and Personalities

In accordance with this invention a Party is either a Person or, more typically (as described above), an Organization having several Persons associated with it. An Organization may be a company or a department in a company. A Party can have one or more Personalities, and each Personality may have an E-mail Address, one or more Telephone Numbers, and a Mailing Address. Preferably, each Party is required to have one primary Personality. Also preferably, each Person that logs into customer service system 100 must have a Password, and that Person is associated with at least one Personality with an E-mail Address that is unique for that Party. A Person logs into the customer service system 100 by providing an E-mail Address and a Password. (In a preferred embodiment, each Person that logs into system 100 must have a unique E-mail Address.) A Person may have more than one Personality, each with a different E-mail Address, but that Person preferably has only one Password. In this manner, a Person may log into customer service system 100 by providing any one of the Person's E-mail Addresses and the Person's one Password.

In a preferred embodiment, employees of customer service system 100 may be represented in system 100 as a Person whose primary Personality may be associated with one or more Accounts via Account Responsibilities. Examples of Account Responsibilities include Super Administrator and Account Representative.

As indicated, each individual at an in-network party is represented in system 100 as a Person with one or more Personalities. Each Personality may be associated with one or more Topics, and each Topic is associated with an Account (i.e., Personalities preferably are not directly associated with an Account). A Person may choose to have only one Personality and use it in connection with all of that Person's Topics, or a Person may have more than one Personality and use each in connection with a different Topic. Once a Person is logged into the system, however, the Person preferably has access to all the Topics with which all of that Person's Personalities are associated.

Topics

In a preferred embodiment, a Topic is associated with a single Account. A Topic may be associated with another Topic in a parent-child relationship. A Topic's children may be referred to as its subtopics, and a subtopic's parent may be referred to as its supertopic. Generally, a Topic may have one or more subtopics.

A Topic may be associated with one or more Personalities via User Roles. Preferably, at least the following User Roles are defined: Topic Administrator, Dispatcher, Expert, and Technical Contact. If a Topic does not have a Supertopic, then in a preferred embodiment that Topic is required to be associated with a Topic Administrator, a Dispatcher, and a Technical Contact. A Topic Administrator for a Topic has Topic Administrator privileges for all of that Topic's Subtopics (but preferably not for that Topic's Supertopics).

Similarly, an Expert is an Expert for the Topic to which the Expert is assigned, as well as all of that Topic's Subtopics. If a Subtopic is assigned to a Dispatcher, however, the Dispatcher for that Topic's Supertopic preferably ceases to be the Dispatcher for the assigned Subtopic (and all of its Subtopics). Likewise, if a Technical Contact is designated for a Subtopic, the Technical Contact for that Subtopic's Supertopic preferably ceases to be the Technical Contact for the designee Subtopic (and its Subtopics). In this manner, the Dispatcher and Technical Contact roles override those roles above them in the Topic hierarchy, whereas the Topic Administrator and Expert roles supplement those roles above them in the Topic hierarchy.

Knowledge Bases, Questions, and Answers

Knowledge-bases

In a preferred embodiment, an Account's Knowledge Base refers to all the customer service data and information that system 100 hosts for the Account, including all the Questions and Answers (FAQ) of that Account. The Questions of a Knowledge Base are organized into a hierarchy of Topics, preferably with one (and only one) Topic being the “top most” Topic and which, by default, may be named after the Account. FAQs and System Forms (see below) may be linked to a single Topic in the Topic hierarchy and thus associated with all the Questions (and associated Answers) in that Topic, as well as all of that Topic's Subtopics. It will be noted that a Knowledge Base need not be represented as a discrete object in the object model, but rather may be represented as the sum total of a number of objects and their relationships.

Questions and Answers

A Question can be associated with zero or more Answers, and an Answer can be associated with one or more Questions. In a preferred embodiment, every Question is associated with a single Topic. Questions may be associated with one or more History Items, that log each activity that occurred with respect to a Question. Likewise, Answers may also associated with one or more History Items. Preferably, both Questions and Answers are Universal Text Objects, as described below.

Both Questions and Answers may have a Valid Start Date and a Valid End Date. Questions or Answers with a Valid Start Date do not become a public member of a Knowledge Base (i.e., a question and answer that can be directly presented to a customer) until after the Valid Start Date has arrived. Likewise, Questions and Answers with Valid End Dates become “private” after that date has arrived. Other actions may also be taken when a Valid End Date arrives, such as the sending of an e-mail alert or the deletion of the particular Question and/or Answer. When a Question is deleted, if any Answers left without Questions are also deleted. When an Answer is deleted, if the Question is left without an Answer, the Question may be transferred out of the Knowledge Base and into the pending question list of the associated Dispatcher.

In a preferred embodiment, a hit counter stores how many times a Question has been accessed. (Hit counters may be reset for a specific Question or for all Questions under a specific Topic.) System 100 also preferably keeps track of the date that a Question was last hit. Also, as indicated, Questions can be tagged as private or public where Public Questions can be displayed to customers, while Private Questions can only be viewed by Topic Administrators and Dispatchers. A Question can be designated for display in a FAQ List that includes the Question's Topic.

An Answer may include an attached Q&A, i.e., a Dispatcher may answer a Question by attaching another Question with its Answer(s). The attached Q&A may be from the Account's Knowledge Base, or it may be from another Account's Knowledge Base and made available to the former Account via a published Knowledge Base Module (or via the customer service network 170)

Universal Text Objects (UTO)

In accordance with a preferred embodiment of this invention UTOs are text objects that have both ASCII and HTML components. UTOs have methods to convert ASCII to HTML and HTML to ASCII. UTOs implement the content interface and have the methods “Render for E-mail” and “Render for Web” (and, optionally, “Render for XML” or “Render for WML”). In a preferred embodiment, when a UTO is told to render itself for the Web, the UTO first tries to use the its HTML component. If the UTO's HTML component is undefined, the UTO calls its method to convert its ASCII component to HTML. When a UTO is told to render itself for e-mail (and the e-mail is not to contain HTML), the UTO first tries to use its ASCII component. If the UTO's ASCII component is undefined, the UTO calls its method to convert its ASCII component to HTML.

Redundant Questions

In a specific embodiment, a Question may be associated with one or more Redundant Questions. Redundant Questions are questions without answers that the customer service system 100 has determined to be successfully answered by the Question with which they are associated.

Customer Service Pages

Customer Service Page

In a preferred embodiment, an Account has one or more Customer Service Pages (CSPs). A CSP is an entry point to customer service system 100 from an Account's Web page(s). Alternatively, a customer may link to system 100 using, for example, a kiosk and/or a computer network other than the Internet. Each CSP has a Response Layout that dictates what information appears on the page. As described below, a Response Layout may include a FAQ, a System Form, or both.

List of Frequently Asked Questions (FAQ)

A FAQ List is a collection of certain designated Questions, that are associated with a Topic (or its Subtopics) to which the FAQ List is linked. Inclusion methods are preferably used to determine which Questions appear in a FAQ List. An inclusion method may be associated with each Topic included in the FAQ List, and therefore the inclusion methods may be different from Topic to Topic. Alternatively, inclusion methods may be associated with the entire FAQ List, so that all the Questions pooled together from all the Topics are included in the FAQ List. In a preferred embodiment, there are two Question inclusion methods are used: (1) a method to include those Questions that have been designated by an Administrator or Dispatcher, and (2) a method to include a specified number of the most popular questions. Both of these inclusions methods may be applied to the same Topic or FAQ List at the same time.

A FAQ List is displayed according to a QList-Layout. System 100 preferably provides a number of popular QList-Layouts from which an Administrator may choose. An Account may also create a custom layout. A QList-Layout preferably includes the following fields: question, answer, date answered, and the topic and/or supertopic of the question.

System Forms

In general, a System Form provides a convenient means for a person outside of system 100 to enter a question. A question is typed in as free-form natural language text (alternatively, key words and/or Boolean searching could be supported). When the question is asked, the user may or may not be required to supply an e-mail address, as determined by a preference of the System Form. If collection of an e-mail address is optional for a given System Form, a preference of the System Form determines whether the e-mail field is displayed at all. Thus, in one embodiment there are three alternatives that a System Form can present: an e-mail address must be collected, an e-mail address can optionally be collected at the customer's discretion, or e-mail addresses are not collected.

A System Form can provide a single line entry field for short questions, a “text area” entry field for long questions, or both with a user interface mechanism to switch between the two, as determined by a preference of the System Form. Preferences may also determine the length of the short entry field and the width and height of the long question field.

A System Form is linked to a particular Topic in an Account's Knowledge Base. The form can then be used to search for Questions contained in that Topic or any of the Subtopics below that Topic in the Topic hierarchy. By default, all the Subtopics are searched when a question is asked via a System Form. However, preferences of the System Form may also allow the form to present a customer with one or more levels of Subtopics, with a select/de-select checkbox next to each Subtopic enabling a customer to narrow the scope of a search.

As noted above, in a specific embodiment a System Form is preferably included in a Customer Service Page via a Response Layout. In alternative embodiments, an Account may incorporate a System Form directly into one of its own Web pages.

List of Similar Questions

A List of Similar Questions is a collection of Questions that is generated by a “Look for Similar Questions” process, but the Questions in the list are generally not related statically. A List of Similar Questions is displayed according to a QList-Layout (as described above in connection with the FAQ List object).

Response Layouts

Response Layouts define the contents of HTML pages (or other similar system interface pages) associated with an Account. Response Layouts may contain one or more of the following elements: Constant Layout Elements (such as page headers and footers), Variable Layout Elements (that are named, and can be altered by processes), a System Form, a FAQ List, and a List of Similar Questions.

The Process Framework

Process Triggers

In accordance with the present invention, Process Triggers may be created to predefine actions that a customer can take, with each triggering a particular Process Path. Examples of Process Triggers include:

(1) “Show Customer Service Page” which is triggered when a link into customer service system 100 is selected (this is an initial entry into the Account's customer service content);

(2) “Click on Question” which is triggered when a customer clicks on a Question in a FAQ List or List of Similar Questions;

(3) “Ask Question” which is triggered when a customer asks a question via a System Form; and

(4) “Submit Question” which is triggered when a customer indicates that a list of Similar Questions do not provide an answer (or when a “Submit Question” process is activated as part of a Process Path).

Process Paths

A Process Path is an arrangement of Processes where one Process is designated as an entry point and where each Process may activate another Process, thus defining one or more possible paths through the Process Path. A Process Path may have one or more exit points, each of which is generally associated with a Response Layout. For a Process Path to be activated, it is assigned to a Process Trigger.

Any data collected from a customer when a Process Trigger is triggered become available to Processes in the Process Path. In addition, the contents of any Variable Layout Elements that are part of the Response Layouts associated with the Process Path are available to, and may be edited by, Processes in the Process Path.

Processes

Broadly, processes are predefined tests and actions. They can interact with their container [Process Path] and can trigger other Processes. Examples of system 100 Processes include: “Alert” (preferably via e-mail); “Match Keyword”; “Edit Variable Layout Element”; “Look for Similar Questions By Keyword”; “Look for Similar Questions Using Natural Language”; “Submit Question” (with an optional message specified by the particular Process).

The framework of Process Paths, Process Triggers, and Processes may further be used to handle other tasks of the customer service system 100, including the functionality of the customer service network 170.

Variable Layout Elements (VLE)

The contents of Variable Layout Elements (VLE) can be prefixed or suffixed by Processes. Each VLE is named when it is placed on a Response Layout and the name is used to reference that VLE in a Process. A Process Path builder may present a pick-list of Variable Layout Elements on the current Process Path's Response Layouts.

In-boxes and Viewing Knowledge Bases

Q&A Holder

A Q&A Holder is associated with a collection of Questions and may be either an In-Box or a Knowledge Base. An In-Box, which may be a Dispatcher's In-Box or an Expert's (e.g., team member) In-Box, holds Questions that are awaiting some action by a person. A Knowledge-Base is a collection of Questions, each of which has one or more Answers, and which do not require action by a person. It is possible for a Question in system 100 to be associated with more than one Q&A Holder at the same time.

Expert's In-box

When a question is assigned to an Expert (e.g., a team member), the Dispatcher assigning the question may specify a “due date” for the Question, i.e., a time by which the Dispatcher would like to receive an answer to the Question from the Expert.

Published Knowledge Base Modules

Knowledge Base Modules

A Knowledge Base Module (KBM) is a collection of questions (and their answers) independent from the Topic hierarchy from which they come. A KBM is associated with an Account and has its own Topic hierarchy. A question may be included in more than one KBM; a question may be included more than once in the same KBM under different Topics. A KBM has a name, which is preferably also the name of the KBM's top level Topic in its hierarchy. In a preferred embodiment, only public questions (and not private questions) can be placed into a KBM. A Question with an Answer that includes a Q&A Attachment from another Account preferably cannot be placed into a KBM. Consequently, a Question preferably cannot be placed into a KBM unless it has at least one Answer that does not include an attached Q&A from another Account. Answers with attached Q&A from the Publisher's own Knowledge Base may be included in a KBM.

Publishing and Subscribing

An account may “publish” one or more KBMs. Other accounts may then “subscribe” to the published KBM. The publishing account may be referred to as a publisher, and a subscribing account may be referred to as a subscriber. When a publisher publishes a KBM, it may specify what other accounts may subscribe to it, or it may publish “publicly” and allow any other account to subscribe to it. A publisher may assign a price to a published KBM and charge subscribers for the (a publisher preferably cannot charge different fees to different subscribers in system 100). A Publisher may indicate whether and how a question in the KBM should be branded by providing HTML and/or ASCII text to include at the bottom of each question when it is viewed by or e-mailed to a subscriber's customer.

A publisher may add Questions and Answers to a published KBM, and preferably that Q&A immediately becomes available to subscribers of that KBM. When a Question (and its Answers) are published in a KBM, the publisher may edit or delete the Question and Answers (i.e., they are alive), but the interface will provide a warning message that the change will effect a published KBM. Such a change to a Question or its Answer(s), however, preferably only affects a subscriber's future use of that Q&A. Questions and Answers already attached to any subscriber's Answers are not changed by such edits. A publisher cannot place a Question from a KBM to which it subscribes into one of its own KBMs.

Certification

When an Account publishes a KBM publicly so that any other Account may subscribe to it, the publisher may request that customer service system 100 certify the KBM. Customer service system 100 may choose to certify KBMs that are general enough as to be attractive to other Accounts and that originate from a reputable publisher. Certification generally does not imply accuracy of the answers, and customer service system 100 preferably clarifies that it is not responsible for certified KBM content. Certified KBMs, however, are preferably given preferred placement in a subscription interface.

Subscription Interface

An account may subscribe to a published KBM via an interface that lists all published KBMs that are available to that Account. The interface presents three different lists to a potential subscriber: a list of published KBMs whose Publishers specifically designated that this Subscriber may subscribe to this KBM, a list of Certified KBMs, and a list of uncertified KBMs.

When a subscriber subscribes to a published KBM, the subscriber effectively places the KBM into its Topic Hierarchy. The Questions and Answers in the KBM may then be placed into a subscriber's FAQ List, and they are available to appear in a List of Similar Questions. Whether to include subscribed-to KBM Questions and Answers in a FAQ List and/or a List of Similar Questions is preferably a decision made by each subscriber. Dispatchers may also attach a Q&A from a KBM to an Answer being composed to one of the Dispatcher's customers. Topics included by a publisher in a KBM cannot be changed by subscribers. However, a subscriber may determine whether to include one or more KBM Topics in the subscriber's FAQ List. Also, a subscriber may have a System Form associated with any one of the KBM Topics (similar to the subscriber's own Topics).

Networking

In-network Networking

An Account may join customer service network 170 and thereby allow other Accounts to assign Questions to it (from the other Accounts' customers). Generally, an Account that joins customer service network 170 may be referred to as a networked Account (or a member of the network), and other Accounts may submit Questions to, or network with, a networked Account. Preferably, an Account joining customer service network 170 designates one of its Topics to be associated with its membership in the network (by default, this may be the networked Account's top-most Topic in its Topic hierarchy). The Dispatcher for this Topic will then receive any network assigned Questions in the Dispatcher's In-Box. A networked Account may specify that only specific Accounts may network with it, or a networked Account may allow any Account to network with it. Accounts that wish to network with (i.e. assign Questions to) a networked Account do not necessarily have to be a member of customer service network 170, but they may be).

Assigning a Question to a Networked Account

Once an Account indicates (via an Administrator interface) that it wants to be able to network with one or more members of customer service network 170, the Account's Dispatcher(s) are then be able to assign Questions to those networked Accounts in their dispatching interface. In a preferred embodiment, when a Dispatcher indicates an intention to assign a Question to a another networked Account, the Dispatcher is first presented with a List of Similar Questions (much like the way a customer might be presented with a List of Similar Questions after asking a question). If the Dispatcher decides that one of the Similar Questions (and its Answers) provide an Answer to the customer's Question, the dispatcher may “attach” that Q&A to their own Answer to the customer's Question. If none of the Similar Questions provide an appropriate answer, or if there are no Similar Questions, the Dispatcher may submit the customer's Question to the Networked Account.

The assigned Question then preferably appears in the Networked Account's Dispatcher's In-Box with an indication that the Question is from the Account that assigned the Question. Preferably, the Networked Account does not have access to the identity or email address of the customer. In a preferred embodiment, the Dispatcher for the Networked Account may provide an answer to the assigned Question in the same way the Dispatcher may provide an answer to a Question from a customer of the Dispatcher's own Account. For example, the Dispatcher may answer the Question using the Dispatcher's own knowledge, assign the Question to one of the Account's own Experts, or Assign it to another Networked Account. System 100 preferably places no limit on the number of network assignments that a Question may undergo to provide an answer. The Dispatcher for the Networked Account may also refuse the assigned Question, similar to the manner in which a Expert (e.g. team member) may refuse an assigned Question. As with other administrative interaction, a note from the assigned party's Dispatcher may be returned to the assigning Dispatcher with the answer or refusal.

When a networked Account answers a Question submitted to it via customer service network 170, the Question and that Account's answer are added to the Account's Knowledge Base and the Q&A is attached to the Answer of the Question in the Dispatcher In-Box of the Account that assigned the Question. Preferably, like any other attached Q&A, the attachment cannot be edited by the original Dispatcher (unless permission to do so is given by the networked Account). The original Dispatcher may keep the attachment or discard it. In addition, because the Answer from the Networked Account is an “attachment” to the original Dispatcher's own Answer, the original Dispatcher may add the original Dispatcher's own words without affecting the content of the attached Answer.

When a Question is assigned to a networked Account, the Dispatcher making the assignment may specify a due date, as in the case of an assignment to an Expert or team member. Also like an assignment to an Expert, alarms or the like are preferably used to draw attention to an over-due Question in an assigning Dispatcher's In-Box, and an assigned Question can be unassigned by the dispatcher at any time. Preferably, if a Question assigned to a first networked Account is further assigned (by a Dispatcher of the first networked Account) to a second networked Account, then if the assignment of the Question to the first networked Account is subsequently revoked (i.e., the Question is unassigned), the assignment to the second networked Account remains active. As a result, in such circumstances, the Dispatcher of the first networked Account may receive an Answer back from the second networked Account and post the Question along with the attached Q&A to the first networked Account's Knowledge Base, even though an Answer is not returned to the original Dispatcher who assigned the Question to the first networked Account.

Out-of-network Networking

As described above, in addition to assigning a Question to an Expert or a Networked Account to be answered, in accordance with the present invention a Dispatcher may assign a Question to an out-of-network party, that is preferably identified by an e-mail address. This e-mail address may be a customer service point of contact for a company or organization, or it may be the e-mail address of an individual.

In one embodiment, a Dispatcher can choose an out-of-network e-mail address from a global list of customer service e-mail addresses maintained and provided by customer service system 100 (in directory 130), choose from a list of e-mail addresses previously used by that Dispatcher, or enter an e-mail address into an entry box. Preferably, when an e-mail address is selected or entered for the first time, the address is added to that Dispatcher's list of previously used e-mail addresses. If customer service system 100 determines that an e-mail address from the global list is invalid, that email address is removed from the global list and from the list of previously used e-mail addresses of all Dispatchers in which it appears (the Dispatchers are preferably notified that the e-mail address is no longer valid and that it was removed). If customer service system 100 changes an e-mail address in the global list, the change is also reflected in any Dispatcher's previously used list that contains the address. Customer service system 100 also preferably maintains a banned list of e-mail addresses to which Dispatchers, system wide, are not allowed to assign Questions (e.g., because the out-of-network party has asked that they no longer be contacted).

As with assignments to Experts and to networked Accounts, assignments to out-of-network e-mail addresses may also specify a due date for a response.

Out-of-network Answers

When a Question is assigned to an out-of-network e-mail address, that e-mail address preferably receives an e-mail message containing: (1) the Question, (2) a link that brings the recipient to a Web page where they can answer the question, and (3) a link that automatically processes a Question refusal. The Web page where the Question can be answered also preferably contains a button that allows the out-of-network party or expert to refuse the question, as well as an interface that allows out-of-network to communicate that they do not want to receive any more e-mails from customer service system 100. Preferably, both the Question answering Web page and the refusal Web page also provide instructions or a link for joining customer service network 170.

The interface where an out-of-network party may enter an answer also provides a selection option for the party to indicate whether they are providing the answer to the Account that assigned the Question to the out-of-network party or if the out-of-network party wants to retain rights to the Answer. If rights to the Answer are retained, a Knowledge Base is created by system 100 for that e-mail address (if it has not yet been created) and the Question and Answer are posted to it. This Knowledge Base is not viewable by any party and is stored so that if the out-of-network party enrolls with customer service system 100, that party will already have a Knowledge Base pre-populated with Questions and Answers that it has previously provided.

The Q&A from the out-of-network party is returned to the original Dispatcher as an attachment to the Question's Answer. If the answering party does not retain its rights to the Answer, the Dispatcher can add that information to the Dispatcher's Knowledge Base, as if the answer had come from an internal Expert.

While the present invention has been described with reference to the preferred embodiments, those skilled in the art will recognize that numerous variations and modifications may be made without departing from the scope of the present invention. Moreover, while a preferred embodiment regarding the system architecture of the present invention has been disclosed in connection with the attached figures, in view of the foregoing description, other system architectures that can carry out one or more of the methods of the present invention may also be available, and all such other system architectures are contemplated to be within the scope of the present invention. Accordingly, it should be clearly understood that the embodiments of the invention described above are not intended as limitations on the scope of the invention, which is defined only by the claims that may later be presented.

What is claimed is:

1. A customer service system comprising:
a database for storing, for each of a plurality of parties in a customer service network, a knowledge base of customer service information; and
a system manager, comprising software, for enabling the sharing of customer service information between the parties in the network.

2. The system of claim 1 further comprising a member interface for allowing a representative of a party to access and interact with the customer service system.

3. The system of claim 1 further comprising a customer interface for receiving a query from a customer of a first party in the network, and wherein the system manager directs the query to a representative of the first party.

4. The system of claim 3 wherein the system manager directs the query to a system in-box for the representative of the first party.

5. The system of claim 3 wherein the system manager enables the representative of the first party to search for a response to the query in the customer service information contained in the knowledge base of the first party.

6. The system of claim 5 wherein the system manager permits the first party to subscribe to at least part of the knowledge base of a second party in the network and thereby further enables the representative of the first party to search for a response to the query in the customer service information contained in the knowledge base of the second party.

7. The system of claim 6 wherein the system manager enables the representative of the first party to add customer service information in the knowledge base of the second party to the knowledge base of the first party.

8. The system of claim 3 wherein the system manager enables the representative of the first party to assign the query to another representative of the first party.

9. The system of claim 3 wherein the system manager enables the representative of the first party to assign the query to a second party in the network.

10. The system of claim 9 wherein the system manager provides the representative of the first party with a contact list comprising contact information for other parties in the network.

11. The system of claim 9 wherein, when the representative of the first party assigns the query to the second party, the system manager directs the query to a representative of the second party.

12. The system of claim 9 wherein the system manager enables a representative of the second party to search for a response to the query in the customer service information contained in the knowledge base of the second party.

13. The system of claim 9 wherein the system manager enables the second party to provide a response to the query to the representative of the first party.

14. The system of claim 13 wherein the system manager enables the representative of the first party to add the customer service information in a response provided by the second party to the knowledge base of the first party.

15. The system of claim 9 wherein the system manager enables the second party to provide a response to the query directly to the customer .

16. The system of claim 3 wherein the system manager enables the representative of the first party to assign the query to a third party not in the network.

17. The system of claim 16 wherein the system manager provides the representative of the first party with a contact list comprising contact information for other parties not in the network.

18. The system of claim 16 wherein the system manager provides the third party with a link to access the system and, once accessed, enables the third party to provide a response to the query.

19. The system of claim 18 wherein the system manager enables the third party to provide a response to the query to the representative of the first party.

20. The system of claim 19 wherein, if permitted by the third party, the system manager enables the representative of the first party to add the customer service information in a response provided by the third party to the knowledge base of the first party.

21. The system of claim 18 wherein the system manager enables the third party to provide a response to the query directly to the customer.

22. The system of claim 3 wherein the query specifies words on which a natural language analysis can be performed.

23. The system of claim 1 wherein the customer service information in each of the knowledge bases comprises a plurality of question and answer pairs.

24. The system of claim 23 wherein the question and answer pairs are categorized by topic.

25. A customer service system comprising:
a first knowledge base of customer service information associated with a first party;
a second knowledge base of customer service information associated with a second party different from the first party; and
a system manager, comprising software, for receiving a query from a customer of the first party and for enabling customer service information contained in both the first and second knowledge bases to be searched in connection with the query.

26. The system of claim 25 wherein the system manager directs the query to a representative of the first party and enables the representative of the first party to search customer service information contained in the first knowledge base.

27. The system of claim 26 wherein the system manager further enables the representative of the first party to search customer service information contained in the second knowledge base.

28. The system of claim 27 wherein the system manager enables the representative of the first party to add customer service information in the second knowledge base to the first knowledge base.

29. The system of claim 26 wherein the system manager enables the representative of the first party to assign the query to the second party.

30. The system of claim 29 wherein, if the representative of the first party assigns the query to the second party, the system manager directs the query to a representative of the second party.

31. The system of claim 30 wherein the system manager enables the representative of the second party to provide a response to the query to the representative of the first party and enables the representative of the first party to add the customer service information in the response to the knowledge base of the first party.

32. The system of claim 25 wherein the system manager maintains the customer service information in both the first and second knowledge bases.

33. A customer service system comprising:
a first knowledge base of customer service information associated with a first party;
a second knowledge base of customer service information associated with a second party different from the first party; and
a system manager, comprising software, for allowing a customer of the first party to search for customer service information contained in both the first knowledge base and the second knowledge base.

34. The system of claim 33 wherein the customer service information in each of the first and second knowledge bases comprises a plurality of question and answer pairs.

35. The system of claim 34 wherein the question and answer pairs are categorized by topic.

36. The system of claim 34 wherein the system manager allows the customer to browse through question and answer pairs in each of the first and second knowledge bases

37. The system of claim 33 wherein the system manager allows the customer to submit a query and attempts to match the query with customer service information in both the first and second knowledge bases.

38. The system of claim 37 wherein the query specifies words and the system manager comprises natural language analysis software for analyzing the query.

39. The system of claim 33 wherein the system manager presents the customer with a customer service page on behalf of the first party.

40. The system of claim 39 wherein the customer service page is a World Wide Web page accessible over the Internet.

41. The system of claim 40 wherein a link to the customer service Web page is provided on a Web site for the first party.

42. The system of claim 39 wherein the customer service page is accessible at a kiosk located in an establishment of the first party.

43. The system of claim 33 wherein the system manager maintains the customer service information in both the first and second knowledge bases.

44. A customer service system comprising:
a knowledge base of product specific customer service information associated with products; and
a system manager, comprising software, for receiving a code specific to a particular product and, in response, enabling customer service information contained in the knowledge base to be searched.

45. The system of claim 44 wherein the system manager enables an information requestor to browse through the customer service information.

46. The system of claim 44 wherein the system manager enables an information requestor to submit a query and attempts to match the query with customer service information in the knowledge base.

47. The system of claim 46 wherein the system manager enables a representative of a party managing the knowledge base to submit the query to a supplier of the particular product.

48. The system of claim 47 wherein, when the supplier provides a response to the query, the system manager enables the representative of the party to add customer service information in the response to the knowledge base.

49. The system of claim 44 wherein the code is a Universal Product Code.

50. The system of claim 44 further comprising a code scanner device, located at a retail establishment, for providing a product code to the system manager.

51. The system of claim 44 wherein the system manager is accessible to a customer over the Internet and the system manager receives a product code via a portable device of the customer.

52. A method for providing customer service information comprising:
storing, for each of a plurality of parties in a customer service network, a knowledge base of customer service information; and
enabling the sharing of customer service information between the parties in the network.

53. The method of claim 52 further comprising receiving a query from a customer of a first party in the network and directing the query to a representative of the first party.

54. The method of claim 53 further comprising enabling the representative of the first party to search for a response to the query in the customer service information contained in the knowledge base of the first party.

55. The method of claim 54 further comprising permitting the first party to subscribe to at least part of the knowledge base of a second party in the network and thereby further enabling the representative of the first party to search for a response to the query in the customer service information contained in the knowledge base of the second party.

56. The method of claim 55 further comprising enabling the representative of the first party to add customer service information in the knowledge base of the second party to the knowledge base of the first party.

57. The method of claim 53 further comprising enabling the representative of the first party to assign the query to another representative of the first party.

58. The method of claim 53 further comprising enabling the representative of the first party to assign the query to a second party in the network. 10

59. The method of claim 58 further comprising providing the representative of the first party with a contact list comprising contact information for other parties in the network.

60. The method of claim 58 comprising, when the representative of the first party assigns the query to the second party, directing the query to a representative of the second party.

61. The method of claim 58 further comprising enabling a representative of the second party to search for a response to the query in the customer service information contained in the knowledge base of the second party.

62. The method of claim 58 further comprising enabling the second party to provide a response t o the query to the representative of the first party.

63. The method of claim 62 further comprising enabling the representative of the first party to add the customer service information in a response provided by the second party to the knowledge base of the first party.

64. The method of claim 58 further comprising enabling the second party to provide a response to the query directly to the customer.

65. The method of claim 53 further comprising enabling the representative of the first party to assign the query to a third party not in the network.

66. The method of claim 65 further comprising providing the representative of the first party with a contact list comprising contact information for other parties not in the network.

67. The method of claim 65 further comprising providing the third party with a link to access the system and, once accessed, enabling the third party to provide a response to the query.

68. The method of claim 67 further comprising enabling the third party to provide a response to the query to the representative of the first party.

69. The method of claim 68 further comprising, if permitted by the third party, enabling the representative of the first party to add the customer service information in a response provided by the third party to the knowledge base of the first party.

70. The method of claim 67 further comprising enabling the third party to provide a response to the query directly to the customer.

71. A method for providing customer service information comprising:
maintaining a first knowledge base of customer service information associated with a first party;
maintaining a second knowledge base of customer service information associated with a second party different from the first party; and
receiving a query from a customer of the first party; and
enabling customer service information contained in both the first and second knowledge bases to be searched in connection with the query.

72. The method of claim 71 further comprising directing the query to a representative of the first party and enabling the representative of the first party to search customer service information contained in the first knowledge base.

73. The method of claim 72 further comprising enabling the representative of the first party to search customer service information contained in the second knowledge base.

74. The method of claim 73 further comprising enabling the representative of the first party to add customer service information in the second knowledge base to the first knowledge base.

75. The method of claim 72 further comprising enabling the representative of the first party to assign the query to the second party.

76. The method of claim 75 further comprising, if the representative of the first party assigns the query to the second party, directing the query to a representative of the second party.

77. The method of claim 76 further comprising enabling the representative of the second party to provide a response to the query to the representative of the first party and enabling the representative of the first party to add the customer service information in the response to the knowledge base of the first party.

78. A method for providing customer service information comprising:
maintaining a first knowledge base of customer service information associated with a first party;
maintaining a second knowledge base of customer service information associated with a second party different from the first party; and
allowing a customer of the first party to search for customer service information contained in both the first knowledge base and the second knowledge base.

79. The method of claim 78 wherein the customer service information in each of the first and second knowledge bases comprises a plurality of question and answer pairs.

80. The method of claim 79 further comprising allowing the customer to browse through question and answer pairs in each of the first and second knowledge bases

81. The method of claim 78 further comprising allowing the customer to submit a query and attempting to match the query with customer service information in both the first and second knowledge bases.

82. The method of claim 81 wherein the query specifies words and the method further comprises performing natural language analysis on the query.

83. The method of claim 78 further comprising presenting the customer with a customer service page on behalf of the first party.

84. The method of claim 83 wherein the customer service page is a World Wide Web page accessible over the Internet.

85. The method of claim 83 wherein the customer service page is accessible at a kiosk located in an establishment of the first party.

86. A method for providing customer service information comprising:
maintaining a knowledge base of product specific customer service information associated with products;
receiving a code specific to a particular product; and
in response to the code, enabling customer service information contained in the knowledge base to be searched.

87. The method of claim 86 further comprising enabling an information requester to browse through the customer service information.

88. The method of claim 86 further comprising an information requestor to submit a query and attempting to match the query with customer service information in the knowledge base.

89. The method of claim 88 further comprising enabling a representative of a party managing the knowledge base to submit the query to a supplier of the particular product.

90. The method of claim 89 further comprising, when the supplier provides a response to the query, enabling the representative of the party to add customer service information in the response to the knowledge base.

91. The method of claim 88 further comprising automatically submitting the query to a supplier of the particular product.

92. The method of claim 91 further comprising, when the supplier provides a response to the query, enabling a representative of the party managing the knowledge base to add customer service information in the response to the knowledge base.

93. The method of claim 86 wherein the code is a Universal Product Code.

94. The method of claim 86 further comprising receiving a product code from a code scanner device located at a retail establishment.

95. The method of claim 86 further comprising receiving a product code over the Internet from a portable device of a customer.

96. A method for providing customer service information comprising:
providing access to a first knowledge base of customer service information associated with a first party;
providing access to a second knowledge base of customer service information associated with a second party different from the first party;
allowing a person to search for customer service information contained in both the first knowledge base and the second knowledge base.

97. The method of claim 96 wherein the person is a customer of the first party.

98. The method of claim 96 wherein the person is a representative of the first party.

99. The method of claim 96 further comprising allowing the person to browse through question and answer pairs in each of the first and second knowledge bases.

100. The method of claim 96 further comprising allowing the person to submit a query and attempting to match the query with customer service information in both the first and second knowledge bases.
